(19) United States
(12) Patent Application Publication
(10) Pub. No.: US 2006/0215035 A1
(43) Pub. Date: Sep. 28, 2006

(54) Fast capture and transmission of information in a portable device

(76) Inventor: Charles J. Kulas, San Francisco, CA (US)

Correspondence Address: Charles J. Kulas, 651 Orizaba Ave., San Francisco, CA, 94132, US

(21) Appl. No.: 11/088,556

(22) Filed: Mar. 23, 2005

(51) Int. Cl. H04N 5/225

(52) U.S. Cl. 348/207.99

(57) ABSTRACT

A panic mode in a device such as a mobile phone having a camera. When the panic mode is triggered an image is captured and immediately transmitted to an external site, such as to a server at a law enforcement authority, a parent's household, etc. Ideally the device does not give an indication as to whether or not the panic mode shot was successful, thereby causing doubt in a wrongdoer who could be the subject of the transferred image. Upon triggering the panic shot the device goes into a lockdown mode whereby interruption of capture and transfer of a record (e.g., image, audio recording, etc.) is not possible or is made very difficult. In one embodiment a back-up permanent power supply is included in the form of a capacitor or small battery so that even if the device's main battery is removed the panic shot can still be transferred. Other features are described.

### BACKGROUND OF THE INVENTION

Improvements in personal safety and protection are valuable and are sought by people and organizations, such as governments, in order to protect a population, family member or fellow being. In some cases, protection can be improved by providing deterrents to wrongdoers. If a wrongdoer feels that a wrongful act will be seen by others, or documented or recorded in a form that will reveal the identity of the wrongdoer then the wrongdoer is less likely to commit the wrongful act.

Some of today's devices such as cameras, audio recorders, biometric detectors (e.g., fingerprint, facial image recognition, DNA sensors, etc.) and other devices provide ways for identifying people and recording actions and can thus act as a deterrent. However, in many cases such devices may not be present where an act is taking place. Or the act may happen too quickly for the device to capture an actor or the act. In other cases, a wrongdoer may destroy the device or otherwise prevent the device from creating an accurate record and providing the record to other people who can arrest the wrongdoer. If a wrongdoer believes that a device has not operated sufficiently to create and preserve a record for presentation to others, the device has most likely failed to be a deterrent.

### BRIEF DESCRIPTION OF THE DRAWINGS

FIG. 1 shows a cell phone with a built-in camera;

FIG. 2 shows the cell phone of FIG. 1 including lenses;

FIG. 3 a device in communication with other devices and sites; and

FIG. 4 shows subsystems in a device suitable for use with the invention.

### DETAILED DESCRIPTION OF THE INVENTION

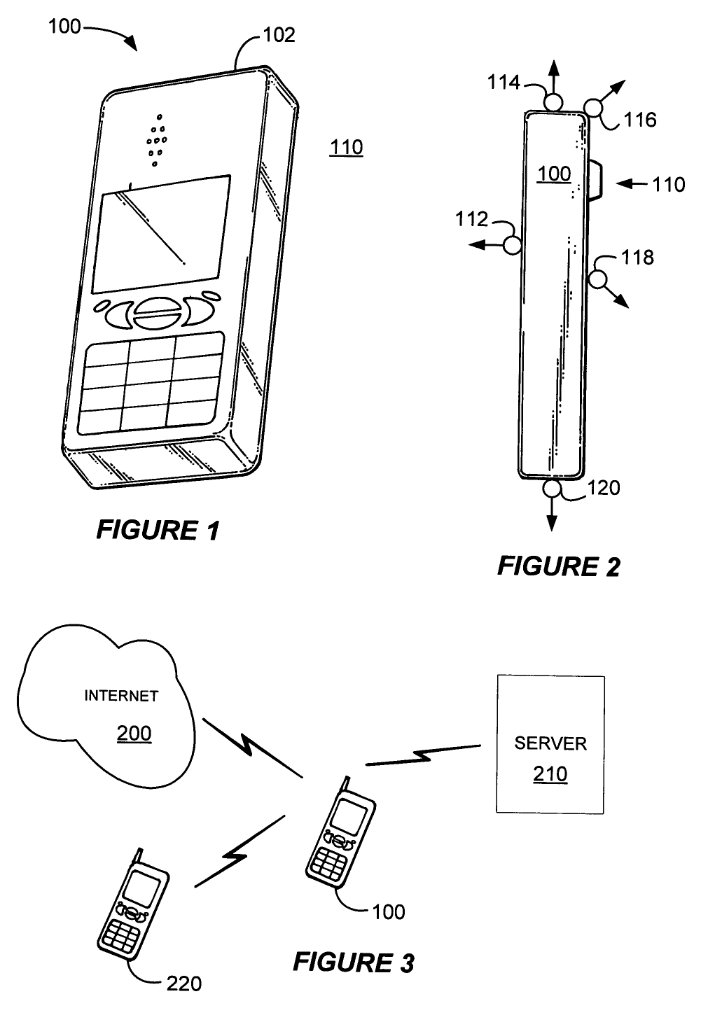

FIG. 1 shows cell phone 100. Although a specific design for a cell phone is presented, any type of cell phone design, or other design for a portable imaging device can be used. For example, a personal digital assistant (PDA), computer (e.g., sub-notebook, laptop, etc.), still or video camera, or other type of device can be provided with features discussed herein. It should be apparent that different types of user controls and variations of operation can be used and still achieve various aspects of embodiments of the invention. FIG. 2 shows cell phone 100 with lens 110 mounted at the back of the cell phone. To take a picture, a user points the lens in the direction of the desired image to capture and activates a control.

One embodiment of the invention provides a “panic shot” mode for a small portable camera. An image can be taken immediately, triggered by, e.g., a button press, audible yell, gesture or motion with the camera, etc. Upon taking the image the camera goes into a non-interruptible transmit mode whereby the image is transferred to another site. The transmission can be by wireless communication such as to a wireless digital network via 802.11x, wireless Ethernet, etc. Simultaneous transmission modes can be used such as a cell phone transmission together with a wireless digital network transmission, infrared transmission, etc. The transmitted image is sent to an external device or destination such as an Internet site, computer, hard disk, etc.

FIG. 3 shows cell phone 100 in wireless communication with external devices or destinations such as Internet 200, server 210, other phone 220. Any number of devices might be the target of a transfer. Multiple targets can be used. Intermediate, or relay devices can be used to send a transfer to an ultimate target. In a preferred embodiment, a pre-designated device or web site under the control of a third party such as a law-enforcement organization is intended as a final destination for a transfer. An identification (ID) code is sent with the image to identify the device and/or owner or user of the device. Associations between ID codes and users/devices can be done at an earlier time by registration or subscription of users. If an overriding governmental law or regulation is put into place, the inclusion panic shot modes, ID codes, and registration of users and/or devices can be made mandatory for manufacturers so that every device is provided with panic shot capability. Widespread knowledge that the panic shot ability is included in every portable device can act as a deterrent to wrongdoers.

Automated alerts can be sent upon receipt of the transmitted image to bring attention to the panic shot incident. For example, if the user is a child, alert email messages, automated phone calls, pager alerts, etc., can be sent to the child's parents. The alerts can also include the transmitted image or other information such as the date and time of the panic shot, recorded audio before, after and/or during the panic shot, etc.

When the image is received other features can be provided such as providing a link to call the originating device (e.g., if the device is a cell phone with camera ability), to contact another person, etc. A preferred embodiment of the invention does not use a call-back feature to the device that originated the panic shot as one goal is to prevent a wrongdoer from knowing whether or not the panic shot was successful. Another goal is to make the wrongdoer believe that a panic shot was taken whether or not such a shot was actually successful.

Making the wrongdoer believe that a panic shot was successful need only create doubt in the wrongdoer's mind as to whether or not the panic shot was taken and transmitted. In this respect, the existence of the panic shot ability for specific devices should be publicized. Ideally, every portable imaging device would have such ability, such as where the ability is know to be required by law, or that such a feature is prevalent throughout standard features of a phone.

A preferred embodiment does not use any indicators or feedback to show the success, failure, or progress of a panic shot or of the panic shot's transmission. In some cases, as when it is dark, it may be desirable to convince a wrongdoer that a shot was taken that will reveal the wrongdoer in the dark. In this case a flash may be used as is common with low-light photography. However, an improvement to this would be to provide panic shot cameras with infrared or other low-light ability (e.g., light amplification, etc.) so that a wrongdoer would be in doubt as to whether a successful image had been taken. I.e. there would be no flash cue—the absence of which would tell the wrongdoer that no panic shot had been taken.

Once a panic shot is initiated, the device goes into a lock down mode where no buttons or controls can interrupt the image transmission. For example, the power-off control would not be active. Additional features provide for preserving data even if the device is attempted to be destroyed or tampered with. If a transmission link is a relatively low-bandwidth connection it may take several seconds or more to complete a transmission. During this time, a wrongdoer might try to remove the battery, smash the device, plunge the device in water, etc. One feature provides a capacitive storage charge or small back-up battery that allows a device to operate for a short time even without a main battery. The back up battery can be, e.g., a “button” type of battery permanently mounted to a circuit, to be used for transmission of a panic shot. In general, any approach to preserving power long enough to complete the image recording and transmission are acceptable.

Another embodiment includes permanent ink or other detectable marking method within the device so that if the device is smashed, the battery attempted to be removed, or other tampering, the ink has a likelihood of staining the person trying to tamper with the device. Such ink, dye or other material can be invisible to the eye in keeping with the principle that it is advantageous to create doubt in the wrongdoer's mind as to whether an identification event has successfully occurred.

In general, the more thoroughly that a lockdown mode can be implemented the greater the benefit in terms of security. If all controls that would interfere with capture and transmission of a record can be made non-functional, and if all tampering can be prevented during capture and transmission, then the chances of obtaining a helpful record are greater. However, some advantages may be realized by using lesser degrees of lockdown. In other words, some controls can be allowed to function. This can provide a feature whereby the panic mode can be interrupted in case it was triggered accidentally. A panic mode might be stopped with the use of a password or code that is entered from the keypad. Or an override signal can be provided by an external source in an area that is restricted from picture taking. Other variations are possible.

One type of camera design includes multiple lenses or image capture points. FIG. 2 shows several points 112, 114, 116, 118 and 120 that can be outfitted with lenses pointing in the directions shown by the arrows. Such lenses can be flush with, or below, the device's outer enclosure. The multiple lenses at different angles can all be triggered to take simultaneous pictures or time-spaced sequences of pictures. This further confounds the wrongdoer's assessment of whether a successful picture has been taken. In some embodiments, the multiple lenses need not all be active and doubt will still be created in the wrongdoer's mind. In other embodiments, only some (i.e., less than all) of the lenses can be made active. A lens at 112 could be particularly useful to show an image of a person taking the panic shot. Peripheral lenses can help take an image of an identifying landmark so that the place where an event occurred can be determined. A witness to the event can be recorded. Other advantages are possible.

A preferred embodiment tries to determine the most important image information and transfer the image information according to priority. This would improve chances for useful information to be transferred before the device is destroyed. For example, the central portion of an image can be sent first. This assumes that a wrongdoer's face might be at the center of the image and if that portion can be transferred it would be the most useful in identification. Where multiple images have been taken, a motion detector, range sensor, infrared sensor or other approach can be used to flag images that are likely to contain a person. Image recognition can be used to determine portions of the image that have important content such as faces, license plate numbers, body shapes, vehicles, etc.

Another feature of the invention includes audio recording and relay. When a panic mode is activated (e.g., by a button press, loud noise (such as yelling), motion detected gesture, etc.) the device can begin audio recording and immediate transmission of the audio, as desired. A user of the device can be trained to start verbally describing the wrongdoer. If there is no indication as to whether the panic mode has been activated then the wrongdoer may be deterred immediately due to fear of the verbal statements resulting in capture. In many instances, the wrongdoer will be known to a victim, or user, of the device. In such a case the user can merely state the known wrongdoer's name. In other cases, the user can start providing a verbal description of the wrongdoer. The audio recording and transmission will proceed in an uninterruptible manner similar to that described above for image capture and transmission.

For transmission, any type of transmission designed to move captured information from the capturing device to another device is acceptable. Wireless Internet, Ethernet, or other network connections can be used to transfer the captured information to a different device or site. If there is a nearby device, the nearby other device (e.g., a PDA carried by another person, a computer in an automobile, etc.) can be alerted with an alarm so that the user of the other device might come to the aid of the user of the capturing device. For example, triggering the panic mode can send out a signal on multiple frequencies, channels, links, etc., to provide location information relative to other devices so that users of the other devices can provide assistance.

Any type of wired or wireless communication can be used. Radio-frequency (RF), infrared, optical, laser, sonic, or other types of communication links can be employed.

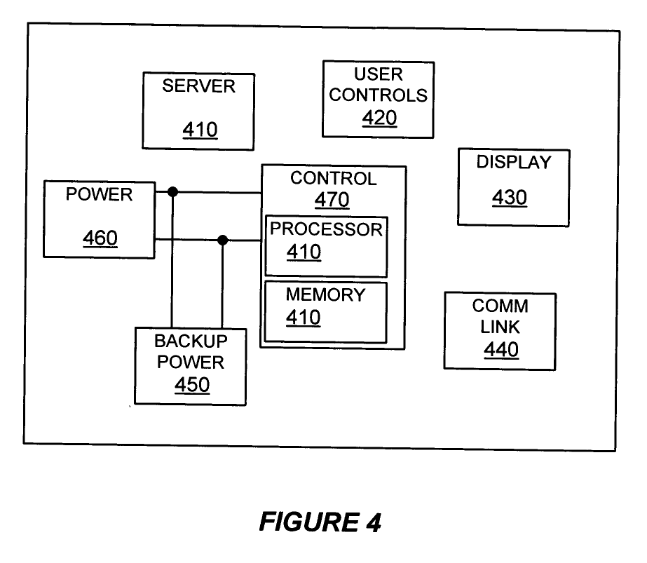

FIG. 4 shows subsystems in a portable device that can be adapted for use with the invention. In FIG. 4, device 400 includes record capture 410, user controls 420, display 430, communication link 440, power source 460, backup power 450 and control system 470 that includes processor 472 and memory 474. Many other types of subsystems and arrangements are possible. Other embodiments may use more or less subsystems connected in different ways.

Record capture 410 can be, e.g., a lens and charge-coupled device (CCD) array, microphone and analog-to-digital (A/D) converter, etc. When a panic mode is triggered, control system 470 causes the capture subsystem to record information as soon as possible and also prevents interruption of record capture. One way of preventing interruption is to inhibit the operation of one or more user controls 420. A message that states that the panic mode capture and transmission was successful can be displayed on display 430 even if the capture and transmission operations are not completed. This could have a deterrent effect on a wrongdoer who might grab the device and try to assess and stop the operation. Another approach is to provide no indication of success or failure of the panic shot. The message indication can be accompanied by an audio alert that can help to cause the wrongdoer to become confused or concerned that a picture was taken and transferred.

Communication link 440 is used to transfer the record to an external source. Transmission can begin immediately, even before record capture subsystem 410 has not completed, as long as there is some data to begin sending. Pre-processing can be performed to optimize, compress, encode, analyze, or perform other operations on the record information to make the information more useful, make the transfer more efficient, or to realize other benefits. Power supply 460 is typically a removable battery that is backed-up with backup power 450 that can be a non-removable battery or other power source. Control system 470 can include any type of device resource such as additional processors, circuitry, storage media, etc.

Although specific embodiments of the invention have been described, variations of such embodiments are possible and are within the scope of the invention. For example, devices may use one or more types of sensing, recording and transmitting. Audio, image, or other types of information can be recorded and transmitted in a panic mode as described herein.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for taking a picture with a portable device, the method comprising:
receiving a signal from a user control to indicate a panic shot mode;
inhibiting interruption of the following operations:
capturing an image with the portable device; and
transferring the image to an external destination.

2. The method of claim 1, further comprising:
preventing interruption of power to components within the portable device that are necessary to perform the operations.

3. The method of claim 1, further comprising:
disabling one or more user controls on the portable device.

4. The method of claim 1, wherein the portable device includes multiple lenses.

5. A method for identifying an event, the method comprising:
associating a user with a device ID;
receiving a transmission from the device ID of an image of an event;
storing at least a portion of the image of the event in association with the device ID; and
using the device ID to associate the user with the transmission.

6. The method of claim 5, further comprising:
sending an alert message.

7. The method of claim 6, wherein the alert message includes an email message.

8. The method of claim 6, wherein the alert message includes a phone call.

9. The method of claim 6, wherein the alert message includes a page to a paging device.

10. A portable device comprising:
a camera;
a wireless communications link;
a user control for generating a panic shot mode signal;
a lockdown mechanism for preventing interruption of operation in response to the panic shot mode signal;
a capture element to convert an image from the lens into an electrical representation; and
a process for transferring the image to an external destination.

11. The portable device of claim 10, further comprising:
a process for preventing interruption of power to components within the portable device that are necessary to perform the operations.

12. The portable device of claim 10, further comprising:
a process for disabling one or more user controls on the portable device.

13. An apparatus for creating a record, the apparatus comprising:
a user input device;
a capture device for immediately creating a record of an event in proximity to the apparatus in response to a signal from the user input device;
a communication link for transferring the record to an external destination; and
a process for inhibiting interruption of the transfer of the record to the external destination.

14. A method for creating a record with a device, the method comprising:
inhibiting interruption of the following operations performed by the device:
creating a record of an event in proximity to the device in response to a signal from a user input control; and
starting a transfer of the record to an external destination.
